(19) United States
(12) Patent Application Publication
(10) Pub. No.: US 2006/0137230 A1
(43) Pub. Date: Jun. 29, 2006

(54) Mailbox crown

(76) Inventor: Jack Harris Speir, Atlanta, GA (US)

Correspondence Address: GEORGE R. REARDON, 3356 STATION COURT, LAWRENCVILLE, GA, 30044, US

(21) Appl. No.: 11/020,718

(22) Filed: Dec. 23, 2004

(51) Int. Cl. G09F 1/00

(52) U.S. Cl. 40/124.14

(57) ABSTRACT

This invention relates generally to an apparatus and method for communication using a mailbox crown, wherein the mailbox crown is imprinted with sun-resistant ink on a weather resistant material having rounded safety corners. The mailbox crown is formed using a combination of scores and cuts, is folded utilizing these scores and cuts, is placed on a conventional mailbox and is secured to the mailbox.

### FIELD OF THE INVENTION

This invention relates generally to communications. More particularly, this invention relates to an apparatus and method for communications using a mailbox crown.

### BACKGROUND OF THE INVENTION

More and more, people are using mailboxes to convey information, show affiliations, announce events, and the like. This may be in the form of tying balloons to the mailbox to announce a party, affixing affiliation stickers to the mailbox, wrapping ribbons around the mailbox, placing signs on the mailbox post, etc.

However, present devices suffer from several drawbacks. Balloons can get tangled in the wind and eventually deflate. Stickers tend to weather quickly and tend to peal at the edges. Ribbons can become frayed. Signs can be dislodged by a strong wind or heavy rain and the lettering on the signs can fade under direct sunlight. Signs also generally have sharp corners, which presents a safety hazard.

While these and other approaches are a good start, improvements are needed to convey information, show affiliations, announce events and the like. Therefore, it is an object of the present invention to provide a mailbox crown that overcomes these and other obstacles.

### SUMMARY OF THE INVENTION

The aforementioned and other objects were achieved, and the above-mentioned disadvantages overcome, by the present invention, by providing a mailbox crown designed to be pliable, to fit over, and to be removably secured to, a mailbox, wherein the mailbox crown uses sun-resistant inks, e.g., ultraviolet inks, weather resistant materials and is disposed for displaying information (home for sale/rent, yard of the month), showing affiliations (e.g., political candidates, educational institutions, sports team, professional organizations), announcing events (e.g., births, birthdays, parties, club meeting), and the like.

In general the mailbox crown is placed on a conventional street side style of mailbox, does not interfere with the usage or function of the mailbox, yet covers a substantial portion of the street side mailbox. The general design is for the mailbox crown to fold down from the top of mailbox, coming down on each side of the mailbox to the bottom edge of the mailbox or slightly below the bottom edge of the mailbox. This is accomplished by a combination of scores and cuts on a flexible, weather resistant material that permits the side panels of the mailbox crown to extend below, to or above the top of the mail box leaving a strip or band of uncut material on the outer edges of the mailbox crown that allows the mailbox crown to be pliable and stay intact and snugly fit across the top of the mailbox. The unfolded shape of the mailbox crown is basically rectangular with rounded safety corners. The mailbox crown has means for removably attaching the mailbox crown that are located near the ground-ward edges of the mailbox crown.

Additional objects and advantages of the invention will be set forth in part in the description which follows, and in part will be obvious from the description, or may be learned by practice of the invention. The objects and advantages of the invention will be obtained by means of instrumentalities in combinations particularly pointed out in the appended claims.

### BRIEF DESCRIPTION OF THE DRAWINGS

The accompanying drawings illustrate a complete embodiment of the invention according to the best modes so far devised for the practical application of the principles thereof, and in which:

FIG. 1 shows left plan view of a mailbox crown according to a preferred embodiment of the present invention.

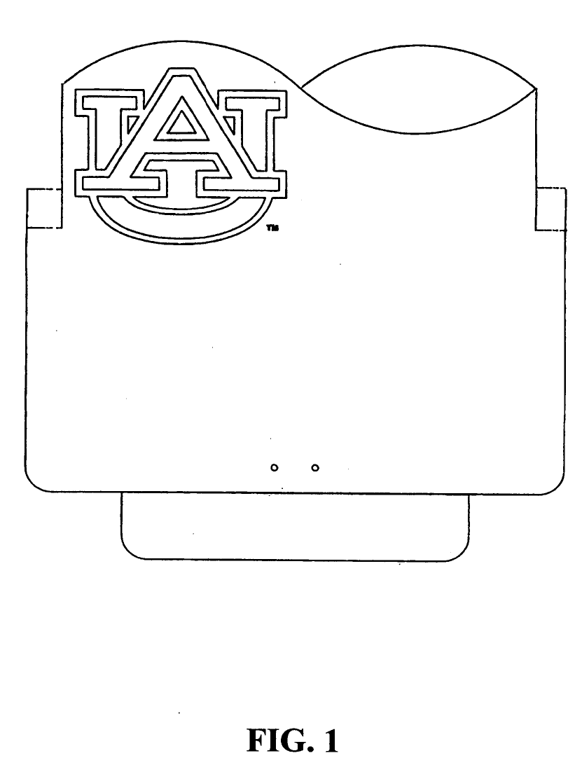

FIG. 2 shows a top plan view according to a preferred embodiment of the present invention.

FIG. 3 shows a top plan view according to a preferred embodiment of the present invention, showing an example of imprinting thereon.

FIG. 4 shows a bottom plan view according to a preferred embodiment of the present invention.

FIG. 5 shows a top plan view according to a preferred embodiment of the present invention, showing the preferred dimensions.

FIG. 6 shows a top plan view of a mailbox crown according to an alternate embodiment of the present invention, showing an alternate pattern of the invention.

FIG. 7 shows a top plan view of a mailbox crown according to an alternate embodiment of the present invention, showing an alternate pattern of the invention and an example of imprinting thereon.

FIG. 8 shows a bottom plan view according to an alternate embodiment of the present invention.

FIG. 9 shows a top plan view according to an alternate embodiment of the present invention, showing the preferred dimensions for the alternate embodiment.

FIG. 10 shows a top plan view according to a second alternate embodiment of the present invention, showing the preferred dimensions for the second alternate embodiment.

### DETAILED DESCRIPTION OF THE INVENTION

The drawings show aspects of the invention. As the drawings are described, reference will be made to the present preferred embodiments of the invention. The terminology used herein to describe the present preferred embodiments is for the purpose of clarification. The invention, however, is not intended to be limited to the specific terminology used. Terminology used to describe each element should be understood to include all technical equivalents that operate in a similar manner to accomplish similar functions.

The present invention is described in relation to a mailbox crown. Nonetheless, the characteristics and parameters pertaining to various embodiments the apparatus and methods described herein may be applicable to a crown for other objects to which it may be attached.

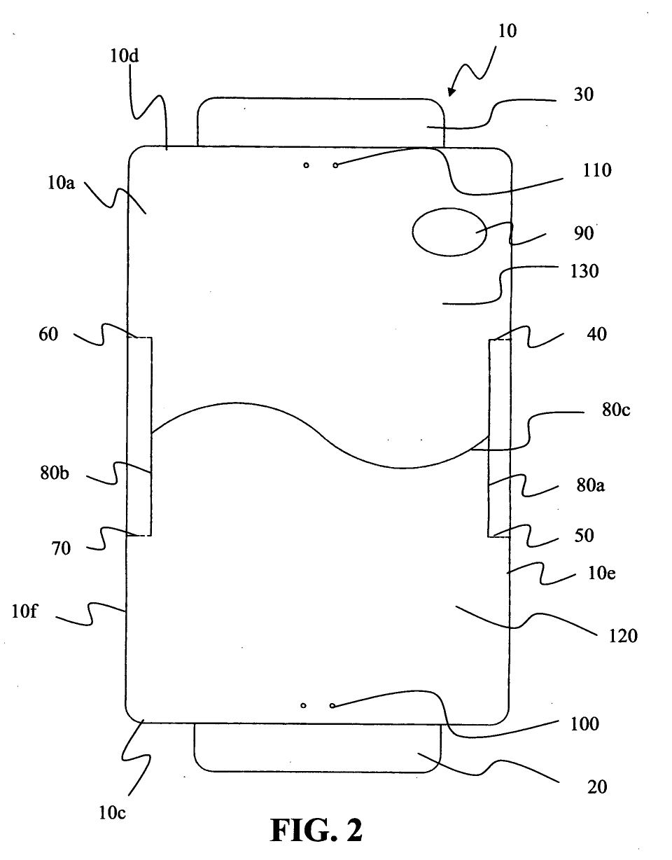

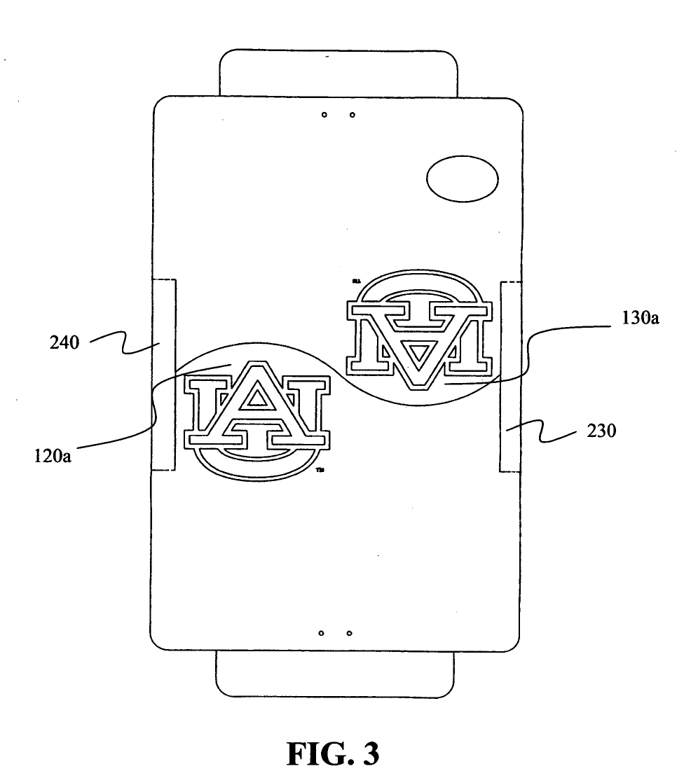

Referring to FIG. 2 and FIG. 3, the preferred embodiment of the present invention is a apparatus 1, wherein apparatus 1 is a mailbox crown assembly generally comprising sheet 10, having top side 10a, bottom side 10b, left side 10c, right side 10d, front side 10e, and back side 10f. Sheet 10 is further comprised of left-side-aligner 20 and right-side-aligner 30. Sheet 10 is further characterized by having rounded corners for increased safety (front left corner 10g, front right corner 10h, back left corner 10i, back right corner 10j, right-side-aligner front corner 10k, right-side-aligner back corner 101, left-side-aligner front corner 10m, and left-side-aligner back corner 10n.

Sheet 10 is further comprised of first score 40, second score 50, third score 60 and fourth score 70. Sheet 10 is further comprised of cut 80, which enables portions of sheet 10 to project above the mailbox top in a near vertical orientation. Cut 80 is further characterized by first cut portion 80a, second cut portion 80b and third cut portion 80c. First cut portion 80a is roughly parallel to the front side 10e and goes from the distal end of first score 40 to the distal end of second score 50. Second cut portion 80b is roughly parallel to back side 10f and goes from the distal end of third score 60 to the distal end of fourth score 70. Third cut portion 80c goes from roughly the midpoint of first cut portion 80a to roughly the midpoint of second cut portion 80b. Third cut portion 80c is roughly in the shape of a single sine wave.

Sheet 10 is further comprised of left-side display area 120, and right-side display area 130. Both left-side display area 120 and right-side display area 130 are disposed to receive inks, preferably sun-resistant inks. The left-side display area is further comprised of a first popup portion 120a. The right-side display area is further comprised of a second popup portion 130a. Sheet 10 is further comprised of a first band 230 and a second band 240 that is formed by the combination of first score 40, second score 50, third score 60, fourth score 70 and cut 80.

Sheet 10 is further comprised of flag-hole 90. Flag-hole 90 is positioned such that it can fit over a mailbox flag when the mailbox crown is placed on a mailbox. Sheet 10 is further comprised of left securing holes 100 and right securing holes 110. Apparatus 1 is further comprised of at least one securing means 140, preferably a nylon zip-tie, which passes through at least one of left securing holes 100 and right securing holes 110 in order to attach apparatus 1 to a mailbox. Other securing means 140 include, but are not limited to, string, yarn, twine, bungee cords, and the like.

The preferred material for sheet 10 is a semi-rigid plastic, e.g., polypropylene or polyethylene. The desired life expectancy of the mailbox crown drives the choice of which material to use for sheet 10. Polyethylene is preferred when a longer life expectancy is desired since polyethylene can better tolerate being exposed to the weather. Polypropylene is the preferred material for short term usage of the mailbox crown, e.g., birthdays, “it's a boy”, “it's a girl”, or holidays.

The preferred printing process for sheet 10 is screen printing. Screen printing is used on heavy weight materials that will not run through off-set printing presses. Screen printing also permits the use of longer life inks and sun fast inks for outdoor use. (Sun-fast inks will not color fade in sunlight.) Screen printing also permits the use of ultraviolet inks, which have a very long and extended life outdoors. Both polypropylene and polyethylene can be printed using the screen printing process using these types of inks.

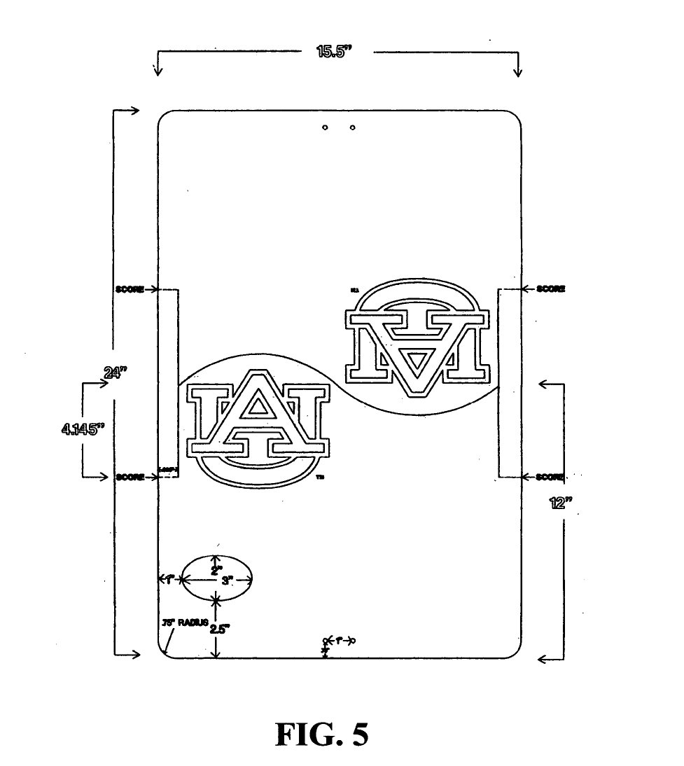

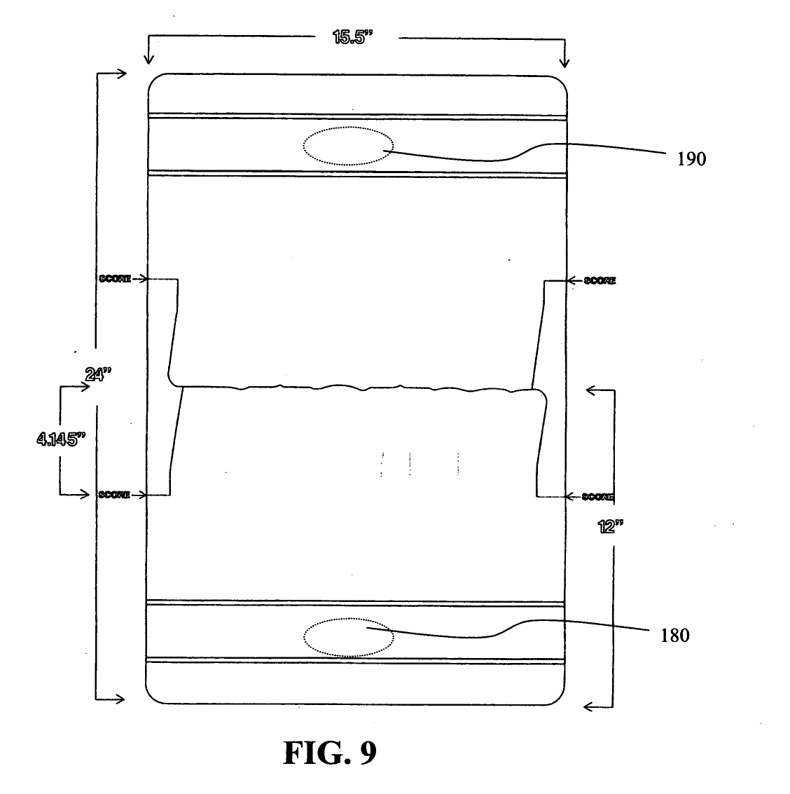

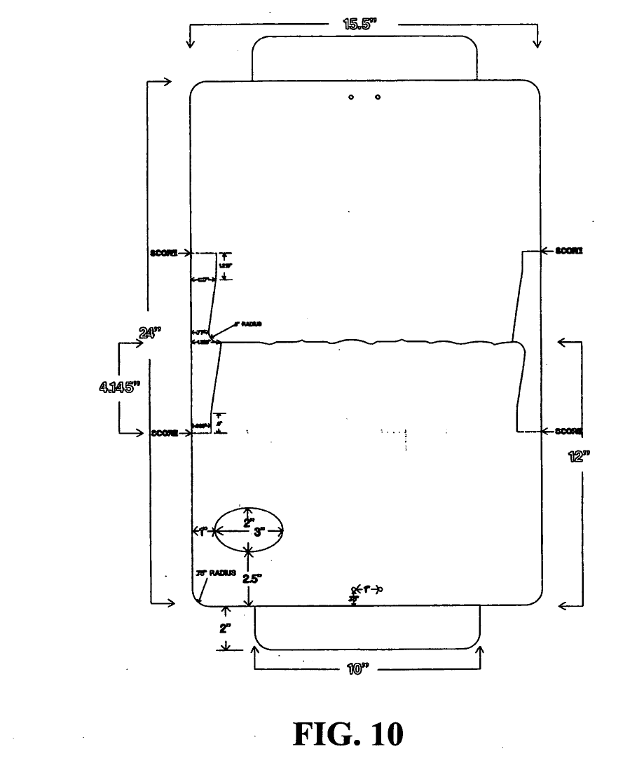

The preferred range of thickness for sheet 10 ranges from 0.020 to 0.080 inches. The thickness used varies based on the desired life expectancy of the mailbox crown. The preferred thickness for sheet 10 is 0.055 inches. The dimensions for the preferred embodiment of sheet 10 are shown in FIG. 5. The dimensions for an alternative embodiment are shown in FIG. 9. The dimensions for a second alternative embodiment are shown in FIG. 10.

To make the mailbox crown, the preferred construction of sheet 10 would be die cutting with a die cut pattern across the center of the design which would be the area covering the top center of the mail box permitting the sides of the cut material to remain up-right. The die cutting for the upright design portion can vary depending on the design to be printed on the two sides displaying the message, logo and the like.

Sheet 10 can be printed with a total ink coverage design or a partial design on the side panels only. In addition to the die cutting differing at the center or top of design, there also could be a space added to the bottom of each side allowing for press-on street- or house-numbers, e.g., an area approximately 3″×10″, with slightly rounded corners on each end of side panels extending below the mailbox. The rounded corners are created by die cutting for the purpose of safety.

Referring to FIG. 3, an example of an affiliation display is shown on the left-side display area 120 and the right-side display area 130.

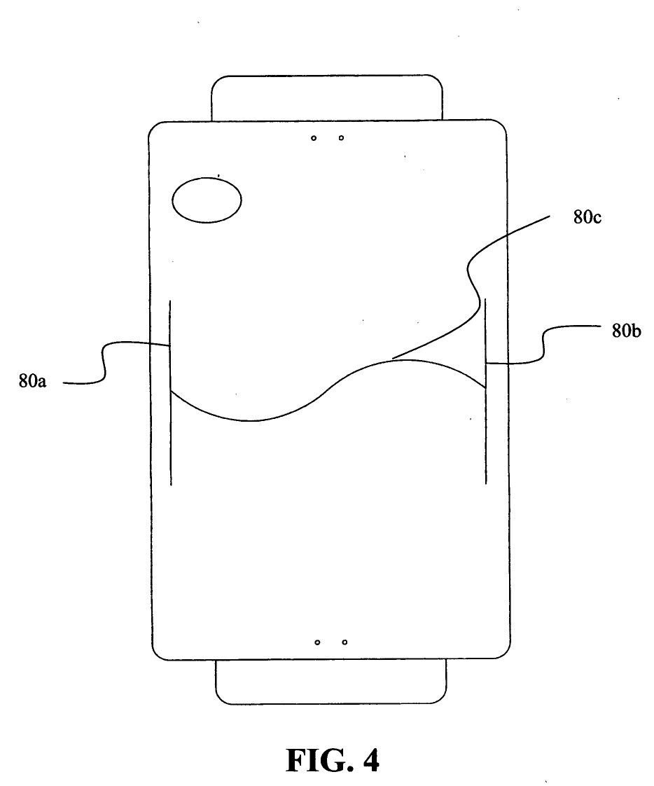

Referring to FIG. 4, bottom side 10b of the preferred embodiment is shown, as well as first cut portion 80a, second cut portion 80b and third cut portion 80c.

Referring to FIG. 5, the dimensions for the preferred embodiment are shown.

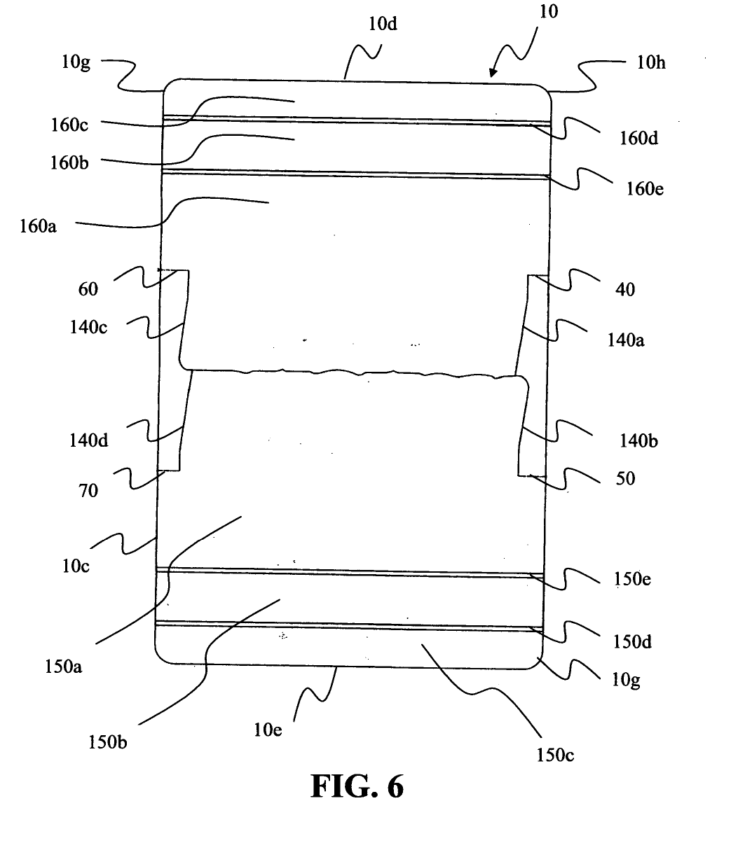

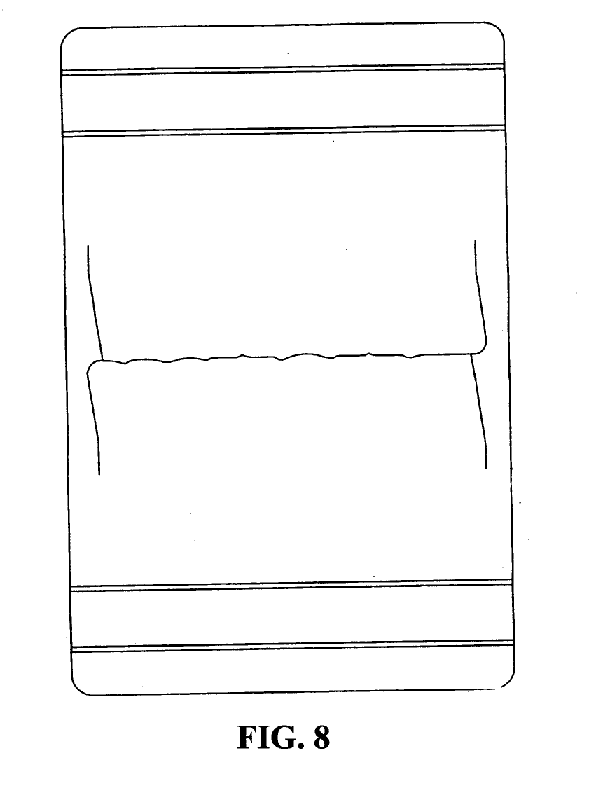

Referring to FIG. 6 and FIG. 8, an alternate embodiment of the invention is shown. The alternate embodiment of the present invention is a mailbox crown assembly generally comprising sheet 10, having top side 10a, bottom side 10b, left side 10c, right side 10d, front side 10e, and back side 10f. Sheet 10 is further characterized by having rounded corners for increased safety (front left corner 10g, front right corner 10h, back left corner 10i, and back right corner 10j. Sheet 10 is further comprised of first score 40, second score 50, third score 60 and fourth score 70. Sheet 10 is further comprised of cut 140. Cut 140 is further characterized by first cut portion 140a, second cut portion 140b, third cut portion 140c, fourth cut portion, 140d, and fifth cut portion 140e. Sheet 10 is further comprised of left-side display area 150, and right-side display area 160. Both left-side display area 150 and right-side display area 160 are disposed to receive inks, preferably sun-resistant inks. Left-side display area 150 is further comprised of first left-side display portion 150a, second left-side display portion 150b and third left-side display portion 150c. Right-side display area 160 is further comprised of first right-side display portion 160a, second right-side display portion 160b and third right-side display portion 160c. Left-side display are 150 is further comprised of first left-side separator 150d and second left-side separator 150e. Right-side display are 160 is further comprised of first right-side separator 160d and second right-side separator 160e. This alternate embodiment of a mailbox crown assembly is further comprised of securing means 170, preferably a hook and loop assembly such as Velcro® along with a connector 200. If only one securing means 170 is used it is preferably positioned at left securing area 180 and right securing area 190. If more than one securing means 170 is used, the left securing area 180 and right securing area 190 are used as reference points to position the multiple securing means 170 for optimum holding. When multiple connectors 200 are used they can be either parallel to each other or cross, depending on the desired effect.

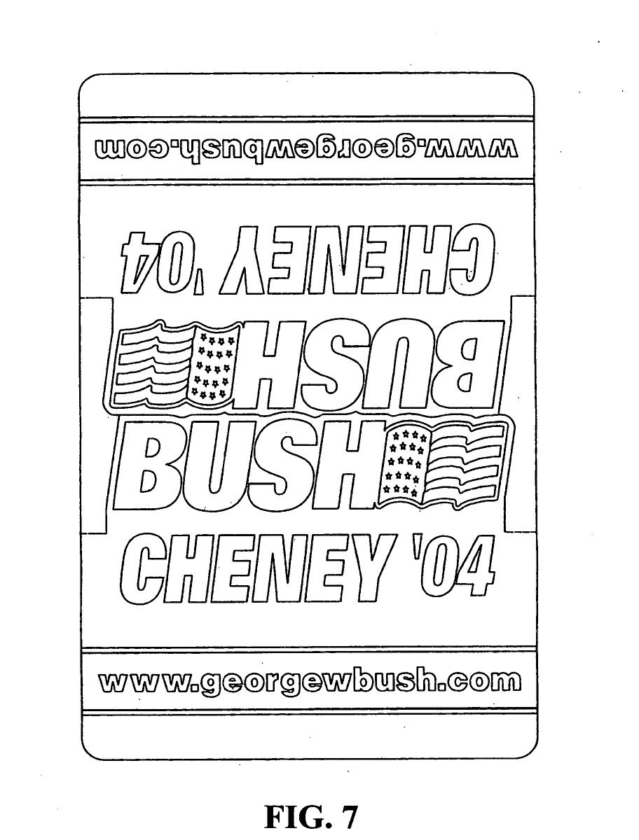

Referring to FIG. 7, an alternate embodiment of the invention is show, with an example of political candidate affiliation.

Referring to FIG. 8, the bottom side of an alternate embodiment is shown, highlighting the cut that enables portions of sheet 10 to project above the mailbox in a near vertical orientation.

Referring to FIG. 9, the preferred dimensions for an alternative embodiment are shown.

Referring to FIG. 10, the preferred dimensions for a second alternative embodiment are shown.

The method of communication is comprised of the following steps:
a) obtaining a sheet of blank material;
b) imprinting information on the top side of the sheet of blank material to form a sheet of imprinted material;
c) scoring four spaced partial lines in the sheet of imprinted material; and
d) cutting a pattern that connects the four spaced partial lines and that forms rounded corners on the sheet of imprinted material to form a cut imprinted sheet of material;
e) Folding the cut imprinted sheet of material to form a mailbox crown;
f) Placing the mailbox crown over a conventional mailbox; and
g) Securing the mailbox crown to the conventional mailbox via a securing means, preferably a plastic zip-tie

The above description and drawings are only illustrative of preferred embodiments which achieve the objects, features and advantages of the present invention, and it is not intended that the present invention be limited thereto. Any modification of the present invention which comes within the spirit and scope of the following claims is considered part of the present invention.

Other embodiments, uses and advantages of the present invention will be apparent to those skilled in the art from consideration of the specification and practice of the invention disclosed herein. The specification and examples should be considered exemplary only.

What is claimed is:

1) A method of communication, comprising the steps of:
a) obtaining a sheet of blank material;
b) imprinting information on the top side of said sheet of blank material to form a sheet of imprinted material;
c) scoring four spaced partial lines in said sheet of imprinted material; and
d) cutting a pattern that connects said four spaced partial lines, forms a first band, a second band, a first popup, a second popup and rounded corners on said sheet of imprinted material to form a cut imprinted sheet of material.

2) A method of communication according to claim 1, further comprising the steps of:
a) folding said cut imprinted sheet of material to form a mailbox crown;
b) placing said mailbox crown over a conventional mailbox; and
c) securing said mailbox crown to said conventional mailbox via a securing means.

3) A mailbox crown, comprising:
a sheet of blank material, wherein said sheet of blanks material further comprised of a top side, a bottom side, a left side, aright side, a front side, a back side, a left-side-aligner, a right-side-aligner, a front left corner, a front right corner, a back left corner, a back right corner, a right-side-aligner front corner, a right-side-aligner back corner, a left-side-aligner front corner, a left-side-aligner back corner, a first score, a second score, a third score, a fourth score, a first cut portion, wherein said first cut portion is roughly parallel to said front side and goes from the distal end of said first score to the distal end of said second score, a second cut portion, wherein said second cut portion is roughly parallel to said back side and goes from the distal end of said third score to the distal end of said fourth score, a third cut portion, wherein said third cut portion goes from roughly the midpoint of said first cut portion to roughly the midpoint of said second cut portion, wherein said third cut portion is roughly in the shape of a single sine wave, a left-side display area, wherein said left-side display area is further comprised of a first popup portion, a right-side display area, wherein said right-side display area is further comprised of a second popup portion, a first band and a second band, a flag-hole, left securing holes and right securing holes, wherein said left securing holes and right securing holes are disposed opposing each other; and
at least one zip-tie.

4) The mailbox crown according to claim 3, wherein said sheet of blank material is polypropylene.

5) The mailbox crown according to claim 4, wherein said sheet of blank material is polyethylene.

6) A mailbox crown, comprising:
a sheet of blank material;
an information conveying means;
a pliable means;
a fastening means; and
a safety means.

7) The mailbox crown according to claim 6, wherein said sheet of blank material is selected from the group comprising polypropylene and polyethylene.

8) The mailbox crown according to claim 7,
wherein said information conveying means is comprised of sun-resistant inks disposed on said sheet of blank material,
wherein said pliable means is comprised of a first inverted U-shaped band and a second U-shaped band formed by a combination of scores and cuts on said sheet of blank material,
wherein said fastening means is selected from the group comprising zip-ties, string, yarn, and bungee cords,
wherein said safety means is comprised of rounded corners.

9) The mailbox crown according to claim 8, further comprising a flag hole.
